(19) United States
(12) Patent Application Publication
(10) Pub. No.: US 2026/0218637 A1
(43) Pub. Date: Jul. 30, 2026

(54) HYDROGEN ENGINE

(71) Applicant: TOYOTA JIDOSHA KABUSHIKI KAISHA, Toyota-shi (JP)

(72) Inventor: Toru SAKUMA, Toyota-shi (JP)

(21) Appl. No.: 19/401,367

(22) Filed: Nov. 26, 2025

(30) Foreign Application Priority Data
Jan. 24, 2025 (JP) 2025-010487

(51) Int. Cl. F01M 13/00

(52) U.S. Cl. CPC F01M 13/00; F01M 2013/0044

(57) ABSTRACT

A hydrogen engine includes a cylinder block, a crankcase connected to a lower part of the cylinder block, and a cylinder head connected to an upper part of the cylinder block. Connecting passages are arranged to connect a cavity of the crankcase and a cavity of the cylinder head. One of the connecting passages is narrower than another one of the connecting passages.

### CROSS-REFERENCE TO RELATED APPLICATIONS

This application is based upon and claims the benefit of priority from Japanese Patent Application No. 2025-010487, filed on January 24, 2025, the entire contents of which are incorporated herein by reference.

### BACKGROUND

### Field

The following description relates to a hydrogen engine.

### Description of Related Art

JP2005-140104A discloses an internal combustion engine. The internal combustion engine includes a cylinder block, a crankcase connected to a lower part of the cylinder block, and a cylinder head connected to an upper part of the cylinder block. The internal combustion engine includes connecting passages extending from the crankcase to the cylinder head.

In a case of a hydrogen engine, some of hydrogen injected into a combustion chamber may leak into the crankcase as blow-by gas and collect inside the crankcase and the cylinder head. The remaining hydrogen may ignite and produce a flame. The flame produced in one of the crankcase and the cylinder head may spread through the connecting passages into the other one of the crankcase and the cylinder head. It is desired to avoid an excessive increase in the pressure caused by combustion of hydrogen.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a hydrogen engine is provided. The hydrogen engine includes a cylinder block, a crankcase connected to a lower part of the cylinder block, a cylinder head connected to an upper part of the cylinder block, and connecting passages each connecting a cavity of the crankcase and a cavity of the cylinder head. At least one of the connecting passages is narrower than at least another one of the connecting passages.

In another general aspect, a hydrogen engine is provided. The hydrogen engine includes a cylinder block, a crankcase connected to a lower part of the cylinder block, a cylinder head connected to an upper part of the cylinder block, and connecting passages each connecting a cavity of the crankcase and a cavity of the cylinder head. At least one of the connecting passages has an opening connected to the cavity of the cylinder head and located upward from an oil surface in the cylinder head. At least another one of the connecting passages has an opening connected to the cavity of the cylinder head and located downward from the oil surface in the cylinder head.

Other features and aspects will be apparent from the following detailed description, the drawings, and the claims.

### BRIEF DESCRIPTION OF THE DRAWINGS

FIG. 1 is a diagram of a hydrogen engine in accordance with an embodiment.

FIG. 2 is a diagram illustrating a propagation speed of flame.

FIG. 3A is a diagram illustrating the operation in accordance with a comparative example.

FIG. 3B is a diagram illustrating the operation of the hydrogen engine shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A hydrogen engine in accordance with an embodiment will now be described with reference to the drawings.

### Structure of Hydrogen Engine 100

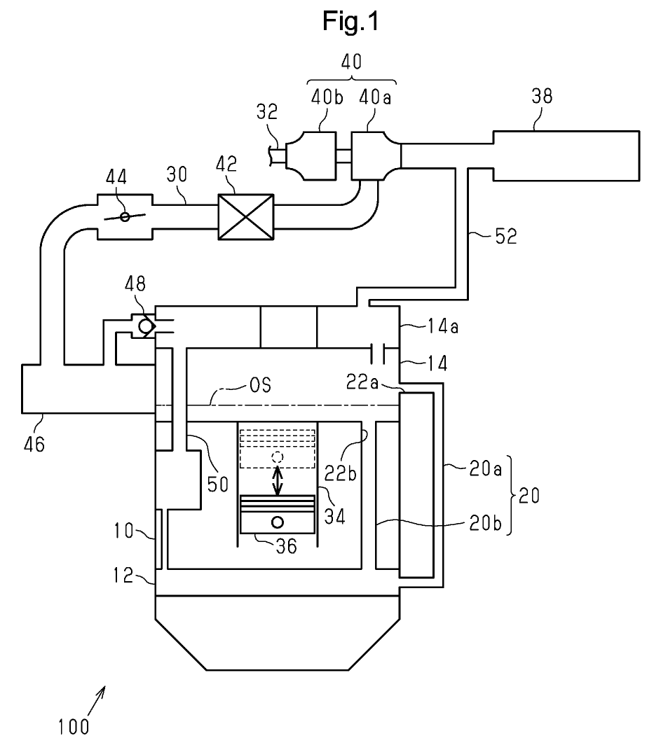

The structure of a hydrogen engine 100 will be described with reference to FIG. 1. The hydrogen engine 100 includes a cylinder block 10, a crankcase 12 connected to a lower part of the cylinder block 10, and a cylinder head 14 is connected to an upper part of the cylinder block 10. A ventilation case 14a is arranged on the cylinder head 14.

The cylinder block 10 includes a cylinder 34. The piston 36 reciprocates inside the cylinder 34. An intake passage 30 and an exhaust passage 32 are connected to the cylinders 34. The intake passage 30 includes, from the upstream side, an air cleaner 38, a compressor 40a of a turbocharger 40, an intercooler 42, a throttle valve 44, and an intake manifold 46 in this order. The turbine wheel 40bof the turbocharger 40 is provided in the exhaust passage 32.

The blow-by gas passage 50 extends from the crankcase 12 to the intake manifold 46. The blow-by gas passage 50 extends inside the cylinder block 10, the cylinder head 14, and the ventilation case 14a. The PCV valve 48 is located between the intake manifold 46 and the ventilation case 14a in the blow-by gas passage 50. The PCV valve 48 adjusts the amount of blow-by gas flowing through the blow-by gas passage 50.

A recirculation passage 52 extends from an intermediate part of the intake passage 30 between the air cleaner 38 and the compressor 40a to the ventilation case 14a. The ventilation case 14a is in communication with the cylinder head 14. Connecting passages 20 are arranged to connect a cavity of the crankcase 12 and a cavity of the cylinder head 14.

### Structure of Connecting Passages 20

The connecting passages 20 include a connecting passage 20a and a connecting passage 20b. The connecting passage 20a has an opening 22a connected to the cavity of the cylinder head 14. The opening 22ais located upward from an oil surface OS in the cylinder head 14. The connecting passage 20a is routed outside the cylinder block 10. The connecting passage 20a may be a pipe or a hose. The connecting passage 20b has an opening 22b connected to the cavity of the cylinder head 14. The opening 22b is located downward from the oil surface OS in the cylinder head 14. The connecting passage 20b is arranged inside the cylinder block 10. The connecting passage 20b returns the oil delivered to a component in the cylinder head 14 to the crankcase 12. There may be one or more connecting passages 20a. There may be one or more connecting passages 20b.

As shown in FIG. 1, the connecting passage 20a has a smaller diameter than the connecting passage 20b. That is, one or more of the connecting passages 20 are smaller than the remaining one or more of the connecting passages 20.

### Operation of the Present Embodiment

As the intake manifold 46 becomes negative, the PCV valve 48 opens. Accordingly, air flows through the recirculation passage 52, the ventilation case 14a, the cylinder head 14, the connecting passages 20a, 20b, the crankcase 12, and the blow-by gas passage 50 in this order. This allows the blow-by gas stored in the crankcase 12 to flow to the intake passage 30.

The hydrogen engine 100 includes a cylinder block 10, a crankcase 12 connected to a lower part of the cylinder block 10, and a cylinder head 14 is connected to an upper part of the cylinder block 10. Connecting passages 20 are arranged to connect a cavity of the crankcase 12 and a cavity of the cylinder head 14. One or more of the connecting passages 20 are smaller than the remaining one or more of the connecting passages 20.

The propagation speed U of the flame surface in each connecting passage 20 is increased as the diameter of the connecting passage 20 is decreased.

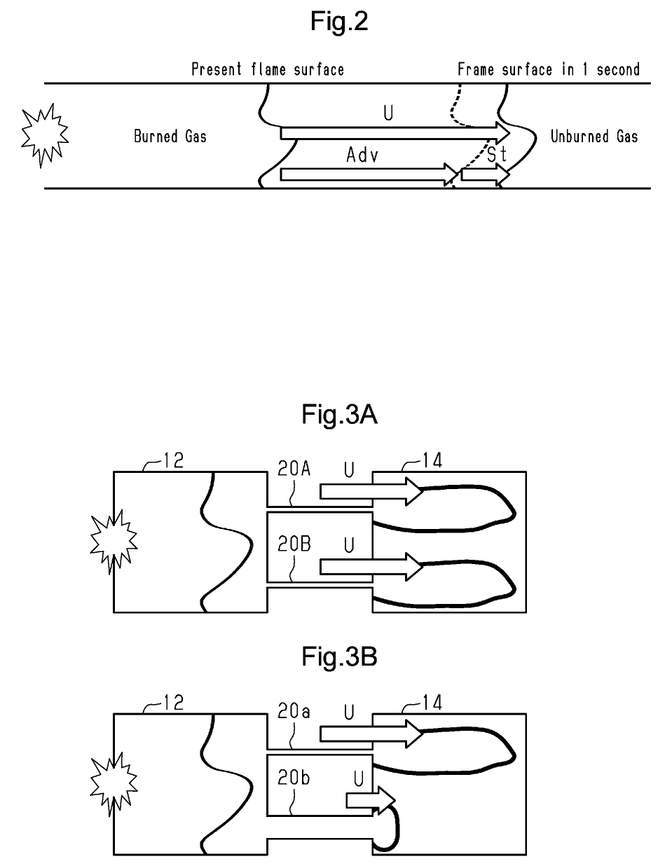

A propagation speed U that is the speed at which a flame surface moves will now be described with reference to FIG. 2. When the hydrogen stored as blow-by gas burns, flame is produced. This forms a fire surface at the boundary between burned gas and unburned gas. The propagation speed U, which is the rate at which flame moves, is the sum of the velocity of turbulent combustion and the velocity of transfer speed Adv caused by expansion of combusted gas.

With reference to FIGS. 3A and 3B, the reason why the propagation speed U of the fire plane in the connecting passage 20 is increased as the diameter of the connecting passage 20 is reduced will be explained. FIG. 3A shows a comparative example in which the diameters of the connecting passages 20A, 20B are the same. The bold curve in the crankcase 12 of FIG. 3A represents the current flame surface. The bold curve in the cylinder head 14 of FIG. 3A represents the flame surface that has moved from the crankcase 12 to the cylinder head 14. FIG. 3B shows the present embodiment in which the connecting passage 20a is narrower than the connecting passage 20b. The bold curve in the crankcase 12 of FIG. 3B represents the current flame surface. The bold curve in the cylinder head 14 of FIG. 3B represents the flame surface that has moved from the crankcase 12 to the cylinder head 14.

The case in which flame generated in the crankcase 12 flows into the cylinder head 14 through the connecting passages 20a, 20b will be described. When a flame surface is spread in the crankcase 12, the flame surface reaches a section of the connecting passage 20 that is open in the crankcase 12. As described above, the propagation speed U is the sum of the turbulent combustion rate St and the transfer rate Adv caused by the expansion of the combusted gas. Since the flow rate of the transfer flow is increased by the inflation of the combusted gas, the cross-sectional area of the connecting passage 20 is increased. Therefore, the propagation speed U of the flame plane in the connecting passage 20 is increased as the diameter of the connecting passage 20 is decreased.

In a comparative example shown in FIG. 3A, the diameters of the connecting passages 20A, 20B are the same. Therefore, there is a high possibility that flame generated in the crankcase 12 hardly reaches the cylinder head 14.

In contrast, the connecting passage 20a is narrower than the connecting passage 20b in the present embodiment. Therefore, flame that is moved through the narrow connecting passage 20a easily reaches the cylinder head 14 before being moved through the wide connecting passage 20b.

### Advantages of the Present Embodiment

(1) As described above, flame that is moved through the narrow connecting passages 20a tends to reach the cylinder head 14 before being moved through the wide connecting passages 20b. Thus, compared to the comparative example, an excessive pressure increase is more likely to be suppressed.

The reason why an excessive pressure increase is more likely to be limited is described for the present embodiment than the comparative example. The amount of chemical reaction occurring in the flame is proportional to the turbulent combustion rate St, the unburned gas density, and the flame area, which is the area of the flame. In the comparison example shown in FIG. 3A, it is highly likely that flame generated in the cavity in the crankcase 12 will reach substantially simultaneously with the cavity in the cylinder head 14. Thus, as compared with the present embodiment shown in FIG. 3B, the flame area is likely to be increased. When the flame area is likely to increase, the chemical reaction is also likely to increase. This means that an increase in pressure due to the chemical reaction also tends to increase. Accordingly, as compared with the comparative example, an excessive pressure increase is more likely to be limited in the present embodiment.

The flame generated in the crankcase 12 flows into the cylinder head 14 through the connecting passages 20a, 20b. The same applies to a case where flame generated in the cylinder head 14 flows into the crankcase 12 through connecting passages 20a, 20b.

(2) One or more of the connecting passages 20 include the connecting passage 20a, which is smaller than the remaining one or more of the connecting passages 20, and the opening 22a in the cavity in the cylinder head 14 is located above the oil surface OS in the cylinder head 14.

The hydrogen engine 100 has a narrow connecting passage 20a, the opening 22a of which is located in the cavity in the cylinder head 14 above the oil surface OS in the cylinder head 14. Since the narrow connecting passage 20a has an opening 22a located at an upper side of the oil surface OS in the cylinder head 14, it is unlikely that oil will hinder the propagation of flame through the narrow connecting passage 20a. Therefore, there is a low possibility that flame generated in the crankcase 12 hardly reaches the cylinder head 14. Accordingly, the above-described configuration readily limits an excessive increase in the pressure.

(3) One or more of the connecting passages 20 include the connecting passages 20a, which are smaller than the remaining one or more of the connecting passages 20 and located outside the cylinder block 10.

According to the above configuration, it is possible to easily adjust the propagation speed U by changing the connecting passage 20a arranged outside the cylinder block 10. The propagation speed U can be easily adjusted without changing the internal structure of the cylinder block 10.

(4) The hydrogen engine 100 includes the cylinder block 10, the crankcase 12, which is connected to the lower part of the cylinder block 10, and the cylinder head 14, which is connected to the upper part of the cylinder block 10. Connecting passages 20 are arranged to connect a cavity of the crankcase 12 and a cavity of the cylinder head 14. One or more of the connecting passages 20 are located above the oil surface OS in the cylinder head 14 at an opening 22a of the cylinder head 14. The remaining one or more of the connecting passages 20 are configured such that the opening 22b in the cavity in the cylinder head 14 is located below the oil surface OS in the cylinder head 14.

In a connecting passage 20b, the opening 22b to the cavity in the cylinder head 14 is located lower than the oil surface OS in the cylinder head 14, oil blocks the connecting passage 20b and tends to reduce the propagation speed U of flame. Therefore, according to the above configuration, there is a low possibility that flame generated in the crankcase 12 hardly reaches the cylinder head 14. Likewise, there is a low possibility that flame generated in the cylinder head 14 hardly reaches the crankcase 12. Thus, an excessive increase in pressure caused by burning the hydrogen stored as blow-by gas is likely to be avoided.

(5) One or more of the connecting passages 20 include the connecting passage 20a, which has an opening 22a in the cavity in the cylinder head 14 above the oil surface OS in the cylinder head 14 and is located outside the cylinder block 10.

According to the above configuration, it is possible to easily adjust the propagation speed U by changing the connecting passage 20a arranged outside the cylinder block 10. The propagation speed U can be easily adjusted without changing the internal structure of the cylinder block 10.

### Modified Examples

The present embodiment may be modified as described below. The present embodiment and the following modifications can be combined as long as they remain technically consistent with each other.

In the above-described embodiment, the opening 22a of the connecting passage 20a is located above the oil surface OS in the cylinder head 14. Instead, the opening 22a may be located below the oil surface OS.

In the above-described embodiment, the connecting passage 20a is located outside the cylinder block 10. Instead, the connecting passage 20a may be formed in the cylinder block 10.

In the above-described embodiment, the connecting passage 20a has a smaller diameter than the connecting passage 20b. Instead, the diameter of the connecting passage 20a and the diameter of the connecting passage 20b may be the same. The opening 22a in the cavity in the cylinder head 14 is located above the oil surface OS in the cylinder head 14. Therefore, a situation is easily avoided in which the propagation speed U of flame in the connecting passage 20a is decreased by closing the connecting passage 20a. Therefore, it is unlikely that flame generated in the crankcase 12 will reach the cylinder head 14 substantially simultaneously through the connecting passages 20a, 20b.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A hydrogen engine, comprising:
a cylinder block;
a crankcase connected to a lower part of the cylinder block;
a cylinder head connected to an upper part of the cylinder block; and
connecting passages each connecting a cavity of the crankcase and a cavity of the cylinder head,
wherein at least one of the connecting passages is narrower than at least another one of the connecting passages.

2. The hydrogen engine according to claim 1, wherein the at least one of the connecting passages includes a connecting passage narrower than the at least another one of the connecting passages and having an opening connected to the cavity of the cylinder head, the opening being located upward from an oil surface in the cylinder head.

3. The hydrogen engine according to claim 1, wherein the at least one of the connecting passages includes a connecting passage narrower than the at least another one of the connecting passages and routed outside the cylinder block.

4. A hydrogen engine, comprising:
a cylinder block;
a crankcase connected to a lower part of the cylinder block;
a cylinder head connected to an upper part of the cylinder block; and
connecting passages each connecting a cavity of the crankcase and a cavity of the cylinder head, wherein
at least one of the connecting passages has an opening connected to the cavity of the cylinder head and located upward from an oil surface in the cylinder head, and
at least another one of the connecting passages has an opening connected to the cavity of the cylinder head and located downward from the oil surface in the cylinder head.

5. The hydrogen engine according to claim 4, wherein the at least one of the connecting passages includes a connecting passage having the opening connected to the cavity of the cylinder head and located upward from the oil surface in the cylinder head, the connecting passage being routed outside the cylinder block.
